(19) United States
(12) Patent Application Publication
(10) Pub. No.: US 2026/0160690 A1
(43) Pub. Date: Jun. 11, 2026

(54) Light-Based Diagnostic System for Simultaneous Visible and Fluorescence Diagnostics

(71) Applicant: Innofiber LLC, Sterling, MA (US)

(72) Inventor: Edward Lawrence SINOFSKY, Dennis, MA (US)

(21) Appl. No.: 19/463,734

(22) Filed: Jan. 29, 2026

Related U.S. Application Data
(63) Continuation-in-part of application No. PCT/US2024/039289, filed on Jul. 24, 2024.
(60) Provisional application No. 63/529,960, filed on Jul. 31, 2023.

(51) Int. Cl. G01N 21/64

(52) U.S. Cl. CPC G01N 21/6456; G01N 21/6486; G01N 2201/0691; G01N 2201/1235

(57) ABSTRACT

In one aspect, a diagnostic method for imaging a target sample is disclosed, which includes concurrently illuminating the target sample with a temporally modulated white light that alternates between an “on” state and an “off” state and a continuous wave (CW) fluorescence-inducing light, acquiring visible image data from the target sample during the “on” state of the modulated white light, acquiring fluorescent image data from the target sample during the “off” state of the modulated white light, and processing the acquired visible and fluorescent image data to generate a reflection image and a fluorescent image of the target sample. In various embodiments, the gain of a camera utilized to acquire the reflection and the fluorescence image data can be changed when transitioning between the “on” and the “off” states of the white light source to compensate for a change in the intensity of light detected by the camera, or the intensity of the white light source can be adjusted to eliminate the need to change camera gain.

### RELATED APPLICATION

The present application claims priority as a continuation-in-part (CIP) application to PCT Application No. PCT/US 2024/039289 filed on Jul. 24, 2024, which is herein incorporated by reference in its entirety. The PCT application, in turn, claims priority to U.S. provisional application number 63/529,960, titled “Light-based diagnostic system for simultaneous visible and fluorescence diagnostics,” filed on Jul. 31, 2023, which is herein incorporated by reference in its entirety.

### BACKGROUND

The present disclosure relates to methods and systems for performing diagnostic assessment of a biological target, e.g., a target tissue of interest.

A variety of diagnostic systems are known. Many of such diagnostic systems use invasive methods for interrogation of a tissue sample, e.g., via biopsy. Non-invasive diagnostic systems, such as those that utilize light are also available. Other systems have been developed to visualize a white light image and a fluorescent image of a target region simultaneously, via excitation of endogenous or exogenous fluorophores, using beam splitter technology, which reduces the signal in both channels.

Notwithstanding great progress that has been made in developing sophisticated diagnostic systems, there is still a need for improved diagnostic systems and in particular those that can generate diagnostic data non-invasively and can display both visible and diagnostic data simultaneously.

### SUMMARY

In one aspect, a diagnostic method for imaging a target sample is disclosed, which includes concurrently illuminating the target sample with a temporally modulated white light that alternates between an “on” state and an “off” state and a continuous wave (CW) fluorescence-inducing light, acquiring reflection image data from the target sample during the “on” state of the modulated white light, acquiring fluorescent image data from the target sample during the “off” state of the modulated white light, and processing the acquired reflection and fluorescent image data to generate a reflection image and a fluorescent image of the target sample.

In various embodiments, the steps of acquiring the reflection image data and acquiring the fluorescent image data are performed by a single optical detector. In some such embodiments, the method further includes automatically adjusting a gain of the single optical detector during various phases of a measurement cycle. For example, the gain of the single detector can be increased for the acquisition of the fluorescent image data relative to a detector gain used for the acquisition of the reflection image data. Further, the gain can be automatically decreased when switching from the acquisition of the fluorescent image data to the acquisition of the reflection image data. Generally, in various embodiments, in each measurement cycle, the gain applied to the detector is alternately switched between two levels, where the lower level is employed during the acquisition of the reflection image data and the higher level is employed during the acquisition of the fluorescent image data.

In various embodiments, the target sample can be a biological sample, e.g., a tissue sample.

In various embodiments, the fluorescence-inducing light has a wavelength in a range of about 405 nm to about 480 nm. By way of example, a UV light source can be employed for generating the fluorescence-inducing light.

In various embodiments, the modulated white light can be generated via superposition of modulated light beams emitted from a red, a blue and a green light source. In some embodiments, the modulation of the intensity of the red, blue, and green light sources can be achieved via Transistor-Transistor Logic (TTL) modulation.

By way of example, the red, blue and green light sources can be lasers generating monochromatic light.

In various embodiments, the modulated white light has a duty cycle in a range of about 10% to about 75%, e.g., in a range of about 25% to about 50%. Further, in various embodiments, the modulation frequency of the white light can be at least 500 Hz, e.g., in a range of about 500 Hz to about 5 kHz (such as 1 kHz). In particular, it has been found that at such high modulation frequencies, both high-quality reflection and fluorescent images can be obtained. In some embodiments, the white light has an intensity in a range of about 50 mW to about 150 mW and the fluorescence-inducing light has an intensity in a range of about 15 mW to about 50 mW.

In various embodiments, the modulated white light and the CW fluorescence-inducing light are delivered to the target sample via a single optical fiber. Further, in various embodiments, a digital camera is employed to acquire the reflection and/or fluorescence image data. In some such embodiments, a red channel of the digital camera is used to acquire the fluorescence image data.

The reflection and fluorescent images can be presented to a user, e.g., via a display. In some embodiments, the reflection and the fluorescent images can be displayed side-by-side or an overlay.

In a related aspect, a diagnostic system for imaging a target sample is disclosed, which includes: at least one visible light source configured to generate temporally modulated white light alternating between an “on” and an “off” state, at least one fluorescence-inducing light source configured to generate light at a wavelength that causes the target sample to fluoresce, at least one optical detector configured to detect at least a portion of the white light reflected or scattered from the target sample and at least a portion of the fluorescent light emanating from the target sample, and an image processor in communication with said at least one optical detector to capture image data corresponding to said reflected or scattered white light and said fluorescent light. The system can further include a controller in communication with said white light source, said fluorescence-inducing light source and said optical detector and configured to: cause the white light source to be temporally modulated between the “on” state and the “off” state, cause the fluorescence-inducing light source to continuously illuminate the target sample during both the “on” and the “off” states of the white light source, and cause the image processor to collect reflection image data during “on” states of the white light source and to collect fluorescent image data during “off” states of the white light source.

In various embodiments, the at least one optical detector is a single optical detector configured to acquire both the visible image data and the fluorescent image data and the controller is further configured to dynamically adjust a gain of the single optical detector during each measurement cycle. For example, the controller can be configured to increase the detector's gain as the detector switches from the detection of the reflected image data to the detection of the fluorescence image data.

In some embodiments, the modulation of the white light source can not only present the ability to monitor the fluorescent radiation in the “off” state of the white light source, but it also makes the adjustment of the average power emitted by the white light source easy and convenient. For example, in some embodiments, the intensity of the light emitted by the white light source can be adjusted via changing the duty cycle of the modulation of the white light source. In some such embodiments, the duty cycle of the modulation of the white light source can be determined as a function of the measured or expected intensity of the fluorescent light. For example, for detection of a weak fluorescent light, the duty cycle of the white light source can be decreased so as to provide additional time for the acquisition of the fluorescent light.

The image processor is configured to generate a reflection image and a fluorescent image from the reflection image data and the fluorescence image data.

In some embodiments, the segments of fluorescence image data acquired during a plurality of temporal periods in which the white light source is “off” can be pieced together and processed to produce a video image of the fluorescent light emitted by the target sample.

In various embodiments, the at least one white light source can include a red, a blue, and a green light source (e.g., red, blue, and green laser sources) that are configured to generate red, green, and blue light. The controller is further configured to modulate each of the red, green, and blue light sources via TTL modulation so as to generate the modulated white light via superposition of the modulated red, blue, and green lights.

In various embodiments, the fluorescence-inducing light source is configured to generate light having a wavelength in a range of about 405 nm to about 480 nm.

In various embodiments, the controller is configured to control a duty cycle of the modulated white light source to be in a range of about 10% to about 75%, e.g., in a range of about 50% to about 75%.

In various embodiments, the system further includes a single optical fiber, where the white light and the light from the fluorescence-inducing light source are optically coupled into the single optical fiber to be delivered to the target sample.

In various embodiments, the optical detector can be a digital camera. In some such embodiments, the controller can be configured to cause the acquisition of the fluorescence image data by “frame grabbing” a red channel of the camera during the off states of the white light source.

In one aspect, a diagnostic system is disclosed, which includes at least one light source capable of generating light in at least two independent spectral channels, wherein one of said spectral channels generates red light and the other spectral channel generates at least blue light, wherein the blue light is capable of eliciting fluorescent radiation from the illuminated biological sample, and at least one camera for detecting at least a portion of any of the illuminating light reflected from said illuminated target biological sample and the fluorescent radiation emitted by the target biological sample.

A controller is operably coupled to said at least one light source for causing temporal modulation of the red light between a first state and a second state during illumination of the target biological sample, where in the first state the red light is on and in the second state the red light is off or has an intensity level less than that of the first state. The camera captures a substantially visible image (herein also referred to as a reflection image) of the illuminated target biological sample during temporal periods in which the red light is in the first state and captures a substantially fluorescent image of the target biological sample during temporal periods in which the red light is in the second state. In various embodiments, the diagnostic red fluorescence can be frame grabbed from the red channel of an RBG (red/blue/green) camera.

The diagnostic system can further include a display for concurrent presentation of the visible and fluorescent images.

In various embodiments, the at least one light source can be further configured to generate light in a green spectral channel. In such embodiments, the controller can be configured to modulate the green light (e.g., between two intensity levels or between an on and an off state) in synchrony with the modulation of the red light, e.g., the red light and the green light can be both on or off.

In various embodiments, the light source can be configured to provide red, green and blue light (herein also referred to as “a first blue light”) associated with red, green, and blue channels and further provide an additional blue light associated with an additional blue channel (herein also referred to as “a second blue light”) having a wavelength that is closer to the UV spectrum than that of the first blue light (e.g., the second blue light can have a wavelength of about 405 nm). In some such embodiments, the RGB light can be modulated to be off when the second blue channel is on. By way of example, when the second blue channel is operable, a frame grabber can capture the output of the red channel of the camera to display as a diagnostic image.

In various embodiments, the at least one waveguide can extend from a proximal end configured to receive the light generated by the light source to a distal end through which at least a portion of the received light can be delivered to the target biological sample. By way of example, and without limitation, the at least one waveguide can be any of a single optical fiber and a bundle of optical fibers. In various embodiments, the at least one waveguide is positioned relative to the target biological sample so as to capture at least a portion of visible light reflected from the biological sample as well as at least a portion of the fluorescent radiation emitted from the sample, and the camera is operably coupled to the proximal end of the at least one waveguide to receive and detect the reflected visible light and the fluorescent radiation captured by the at least one waveguide. Alternatively, in some embodiments, a camera capable of obtaining visible and fluorescent images can be positioned in proximity of the target biological sample (e.g., it can be mounted onto the tip of an optical fiber delivering the light to the sample) to acquire visible and fluorescent image data.

In various embodiments, the at least one waveguide includes a first waveguide for delivering the red light and a second waveguide for delivering the blue light (or a combination of the blue and the green light) to the target biological sample.

In some embodiments, the light source can include a red light source, a green light source and a blue light source or a red light source, a green light source and two blue light sources with different wavelengths In other embodiments, rather than utilizing a green light source, a phosphorescent element that is configured to receive the blue light and generate phosphorescent radiation in response to excitation via the blue light can be utilized, where the phosphorescent radiation can have spectral components in a range between the blue and the red light. By way of example, and without limitation, the phosphorescent element can include Ce:LuAG.

In various embodiments, the at least one waveguide can include a first waveguide for delivering light to the target biological sample and a second waveguide for transmitting visible light reflected from the illuminated target sample and the fluorescent radiation elicited from the target sample to the camera. In some embodiments, a single waveguide, e.g., a single optical fiber, may be utilized for delivery of light in all spectral ranges to the target tissue as well as for collecting the reflected and/or fluorescent radiation.

In various embodiments, the waveguide can transmit a red light, a green light, a first blue light and a second blue light (e.g., a blue light having a wavelength close to the UV region of the spectrum, e.g., a wavelength of 405 nm) to the target sample. The combined red, blue and green light can be modulated to be off when the second blue light is on. By way of example, a diagnostic signal from the target tissue can be obtained from a red channel of an RGB camera.

In various embodiments, the light source and the camera can be mounted on a common mount. In some such embodiments, the light source can include a blue, a green and a red light source that surround the camera. Further, in some embodiments, the light source may provide an additional blue light, that is, the light source can provide a red light, a green light, a first blue light and a second blue light having a different wavelength than the first blue light.

In a related aspect, a diagnostic system is disclosed, which includes a blue light source for generating blue light, wherein the blue light can excite at least one fluorophore in a target biological sample to cause the fluorophore to generate fluorescent radiation and an optical coupler for delivering the blue and the red light to the optical fiber via the proximal end thereof such that the light propagates along the optical fiber to reach the distal end of the optical fiber, where at least a portion of the light exiting the distal end of the optical fiber can illuminate a target biological sample. The diagnostic system can further include a controller in communication with the blue and the red light sources for controlling operation thereof, where the controller is configured to cause temporal modulation of the red light between an off and an on state. A detector is configured to acquire images of the fluorescent radiation during one or more time intervals in which the red light source is off. The detector and/or an image processing/analysis unit coupled to the detector can have digital frame grabbing capability to produce a visible and a fluorescent image in real time. By way of example, the frame grabbing can be applied to the red channel of a detecting camera mounted either on the tip of a fiber optic waveguide or otherwise coupled to the fiber optic waveguide.

Further understanding of various aspects of the present teachings can be obtained with reference to the following detailed description in conjunction with the associated drawings, which are described briefly below.

### BRIEF DESCRIPTION OF THE DRAWINGS

FIG. 1A is a schematic view of a diagnostic system according to an embodiment of the present teachings,

FIG. 1B is a schematic view of a diagnostic system according to the embodiment that includes an additional blue laser providing radiation at a wavelength of 405 nm.

FIG. 2A schematically depicts an example of a temporal modulation of red and optionally as well as the green channel to illuminate a target biological sample,

FIG. 2B schematically depicts temporal modulation of the RGB channel compared to a second blue channel (B2) at a wavelength of 405 nm,

FIG. 3A is a schematic view of a light source suitable for use in the practice of the present teachings, which is coupled to the distal end of an endoscope for providing illumination of a target tissue,

FIG. 3B is a schematic view of a camera surrounded by a plurality of light sources, which is coupled to the distal end of an endoscope for illuminating a target tissue and detecting visible and fluorescent images of the illuminated target tissue,

FIG. 4 schematically depicts a diagnostic system according to an embodiment in which a phosphorescent element is utilized for generating light with spectral components between the blue and green light.

FIG. 5 schematically depicts that in some embodiments an optical fiber is utilized for delivering blue light to the target biological sample and another optical fiber is utilized for delivering the red light (or a combination of red and green light) to the sample,

FIG. 6 schematically depicts that in some embodiments an optical fiber (or a bundle of optical fibers) is utilized for delivering light generated by an RGB or an RPB source to a target biological sample.

FIG. 7 is a flow chart depicting various steps of an embodiment of a diagnostic method according to the present teachings in which a target sample, e.g., a target biological sample (such as a target tissue sample), is illuminated concurrently with a modulated white light and a continuous fluorescence-inducing light, such as a near-UV/violet light, and reflection image data and fluorescent image data are collected during “on” and “off” states of the white light, respectively, where the reflection and the fluorescent image data are analyzed to generate reflection and fluorescent images of the target sample.

FIG. 8 is a timing diagram illustrating acquisition of reflection and fluorescent image data from a target sample, such as a target biological sample, where Panels A, B, and C depict modulation of the white light at three duty cycles of 75%, 50%, and 25%, respectively. The reflection image data is collected during the “on” states of the white light source and the fluorescent image data is collected during the “off” states of the white light source.

FIG. 9A is a schematic diagram depicting a system according to an embodiment of the present teachings.

FIG. 9B is a timing diagram providing an example of an operational mode of the system illustrated in FIG. 9A.

### DETAILED DESCRIPTION

The present disclosure is related to diagnostic methods and systems, which employ light for illuminating a target tissue of interest as well as interrogating the target tissue, e.g., via excitation of native fluorophores or non-native fluorophores, to acquire diagnostic signatures of the target tissue.

Various terms are used herein in accordance with their ordinary meanings in the art and to the extent that a clarification may be needed, various definitions are provided below.

The blue portion of the electromagnetic spectrum refers to wavelengths in a range of about 405 nm to about 480 nm, the red portion of the electromagnetic spectrum refers to wavelengths in a range of about 600 nm to about 700 nm, and the green portion of the electromagnetic spectrum refers to wavelengths in a range of about 480 nm to about 580 nm.

The terms “blue light,” “green light,” and “red light,” as used herein, refer, respectively, to light having at least one wavelength in the blue, the green and the red portion of the electromagnetic spectrum. The term “white light,” as used herein, refers to light whose spectrum includes contributions from the blue, the red as well as one or more of the wavelengths between the blue and red portions of the electromagnetic spectrum, typically, in a range of about 450 nm to about 650 nm.

A spectral channel refers to a subsystem that can generate radiation in a spectral band, e.g., in the blue, the green or the red portion of the electromagnetic spectrum. As used herein, two spectral channels are independent when each can be activated and deactivated independent of the other.

The term “about” as used herein to modify a numerical value indicates a deviation of at most 10% around that numerical value. The term “substantially,” as used herein, refers to a state or condition that deviates, if any, from a complete state or condition by at most 5%.

The terms “radiation” and “light” are used herein interchangeably to refer to a collection of photons.

The term “on” as used herein to describe the state of a light source refers to an activated state of the light source in which the light source generates light. Further, the term “off” as used herein to describe the state of a light source refers to a deactivated state of the light source in which the light source generates no light, or a state in which the intensity of the light generated by the light source is significantly less than the respective intensity of the light generated in the on state of the light source (e.g., lower in intensity by 5 dB or more).

The term “modulated light source” and similar phrases refer to an operational state of the light source in which the light source is successively switched between the “on” and the “off” states.

The term “white light” as used herein refers to light that has a spectral composition suitable for generating a visible optical image of a target sample. For example, the spectrum of the white light can include at least contributions from the red and blue portions of the electromagnetic spectrum and can further include green light and/or a plurality of other wavelengths between the red and blue portions of the electromagnetic spectrum, such that it is perceived by an optical detector or a user as substantially white light.

The terms “light” and “radiation” are used herein interchangeably to refer to electromagnetic radiation.

As used herein, the term “fluorescence-inducing light” refers to electromagnetic radiation having one or more excitation wavelengths effective to cause electronic excitation of at least one native (endogenous) and/or exogenous fluorophore present in a target sample such that the fluorophore emits fluorescent light upon relaxation. The term encompasses ultraviolet, visible, and near-infrared radiation as well as coherent or incoherent radiation.

The term “reflection image data” refers to data generated via detection of at least a portion of the white light that is returned from an illuminated target sample (e.g., via reflection and/or scattering). The term “reflection image” refers to an image of the target sample generated based on the reflection image data.

The term “fluorescence image data” refers to data generated via detection of at least a portion of a fluorescent light emitted by the target sample in response to illumination of the target sample by the fluorescence-inducing light.

The term “monochromatic light” as used herein refers to electromagnetic radiation having a dominant center wavelength (λ₀) and a spectral bandwidth, measured as full width at half maximum (FWHM), not greater than about 2% of the central wavelength with at least about 80%-90% of the total radiant power confined within ±(FWHM/2) of the central wavelength, as measured by a spectrometer with spectral resolution finer than one-fifth of the specified FWHM under the stated operating conditions.

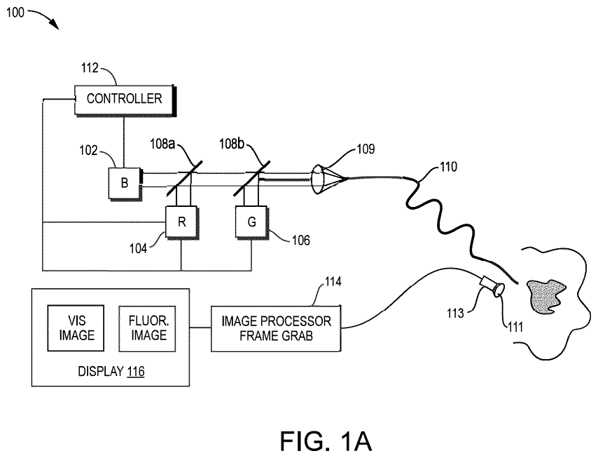

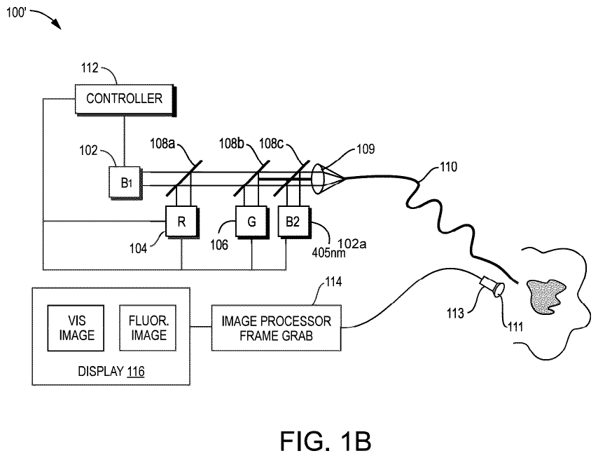

FIG. 1A schematically depicts a diagnostic system 100 according to an embodiment of the present teachings, which includes three radiation sources 102, 104, and 106 generating light in different spectral regions of the electromagnetic spectrum. More specifically, in this embodiment, the light source 102 generates blue laser light, the light source 104 generates red laser light and the light source 106 generates green laser light. For example, laser diodes can be used as these radiation sources. In various embodiments, the output power of the laser light sources can be, for example, in a range of about 0.1 W to about 1 W.

The diagnostic system 100 includes two beam splitters 108a/108b that can receive and direct the radiation along a co-axial direction to an optical coupler 109, which couples the three radiation beams into the proximal end of an optical fiber 110. The radiation exiting the distal end of the optical fiber can be used for illumination and diagnostic purposes. The angle of the emitted illumination light is increased to at least match the imaging field of view angle.

A controller 112 can control operation of the laser light sources so as to allow their independent activation. In some embodiments, such independent activation of the laser light sources can be utilized in the use of the diagnostic system 100 in diagnostic applications. By way example, the controller can cause the modulation of the red laser source 104, e.g., via its periodic activation and deactivation, while allowing continuous emission of the blue and the green lasers 102 and 106. In various embodiments, such modulation of the laser light sources can allow illuminating the target tissue, e.g., for visual inspection, while acquiring diagnostic information regarding the target tissue.

With continued reference to FIG. 1A, the diagnostic system 100 can further include a camera 113 that is positioned in proximity of the target biological sample and can collect radiation reflected from the illuminated target biological sample as well as the fluorescent radiation elicited from the sample via excitation of one or more fluorophores in the sample via the blue radiation and generate imaging data. In some embodiments, a fourth color at a wavelength of 405 nm may be added to enhance the fluorescence. In this embodiment, the diagnostic system 100 further includes a focusing lens 111 that images the target onto the digital camera 113 or a fiber bundle that would then transmit the radiation to the digital camera.

An image processor/frame grabber 114 in communication with the camera can receive the imaging data generated by the camera and process the imaging data. In particular, the image processor/frame grabber 114 can grab frames of image data corresponding to the fluorescent radiation during the temporal periods in which the red light or the combination of the red and the green light is in an off state and process the fluorescence image data, generated during periods in which the red light source or the combination of the red and the green light source is off, to generate a fluorescent image to be displayed via a display 116. By way of example, a diagnostic image can be obtained by monitoring the red channel of the camera output while the red visible source is temporarily off. The image processor/frame grabber 114 can also process the reflected visible light to generate a visible image of the target biological sample, which can be also displayed via the display 116. In this embodiment, the visible and the fluorescent images are displayed concurrently in two separate panels on a single display screen. In other embodiments, the visible and the fluorescent images can be displayed with the fluorescent image overlayed on the visible image. In other embodiments, two separate displays may be used, one for displaying the visible image and another for displaying the fluorescent image.

By way of illustration, FIG. 1B schematically depicts a diagnostic system 100′ according to another embodiment, which is similar to the above diagnostic system 100, but further includes an additional blue source 102a (B2), which generates blue light at a wavelength different from the wavelength of the blue light generated by the blue light source 102. In other words, in this embodiment, the diagnostic system 100′ includes two blue light sources 102 (B1) and 102a (B2) generating blue light at different wavelengths. By way of example, and without limitation, in this implementation, the additional blue light source 102a generates blue light with a wavelength of 405 nm. A beam splitter 108 c receives the light generated by the additional blue light source 102a and directs the received light to the optical coupler 109, which in turn couples the light into the fiber waveguide 110. By way of example, the beam splitter 108c can be a long pass filter that transmits the RGB wavelengths while reflecting the wavelength associated with the blue light generated by the additional blue light source 102a. In various applications, the wavelength of 405 nm can elicit a stronger fluorescent signal than a wavelength of 450 nm, which can be, for example, the wavelength of the blue light generated by the blue light source 102. In this embodiment, all four wavelengths, i.e., red, green, and two blue wavelengths, are simultaneously coupled into the fiber waveguide 110, which delivers the light from the light sources to the target sample for diagnosis.

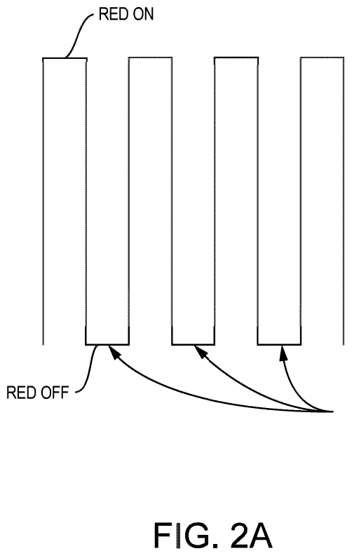

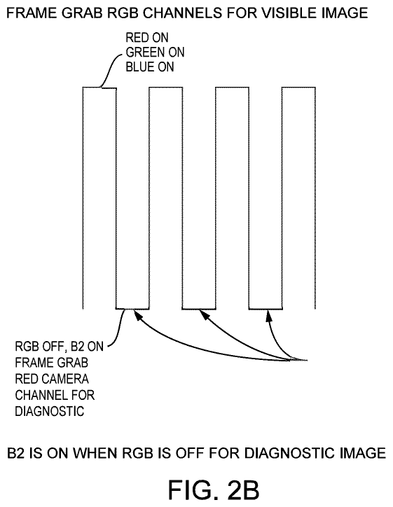

By way of illustration, FIG. 2A schematically depicts a periodic activation and deactivation of the red laser source in the above embodiment of the diagnostic system 100 according to the present teachings. During an illumination period, the blue light or the combination of the blue and the green light provides a continuous illumination of the target biological sample while the red light undergoes intensity modulation, e.g., between an on and an off state. During the time intervals in which the red laser as well as the blue and green lasers are activated, white light is generated for illuminating the target area (e.g., a tissue portion) of interest. During the time intervals in which the red laser light is off, the target site is illuminated via only the blue and the green light. As discussed above, when the red laser light is off, the blue light can cause fluorescent emission from the target site of interest, which can be captured, e.g., by a camera. For example, the camera can frame grab images during periods in which the red laser is in the off state and have full white spectral coverage during periods in which the red laser is in the on state. In some such embodiments, the images acquired during the off state of the red laser can be analyzed for diagnostic purposes. Use of only the red channel from the camera effectively filters out the blue or the green light that may be on when the diagnostic measurement is made.

By way of illustration, FIG. 2B schematically depicts a periodic activation and deactivation of the combined red, green and first blue channels (herein also referred to as “the entire RGB channel”) in the above diagnostic system 100′ while the second blue channel providing a wavelength closer to the UV wavelength spectrum remains activated (e.g., the first and the second blue light sources can provide light with a wavelength of 450 nm and 405 nm, respectively). During the time intervals in which the entire RGB channel is off, a frame grabber of the red channel of the camera can acquire diagnostic image(s) of the target sample. Similar to the previous embodiment, use of the red channel from the camera effectively filters out the first and the second blue lights that may be on when the diagnostic measurement is made.

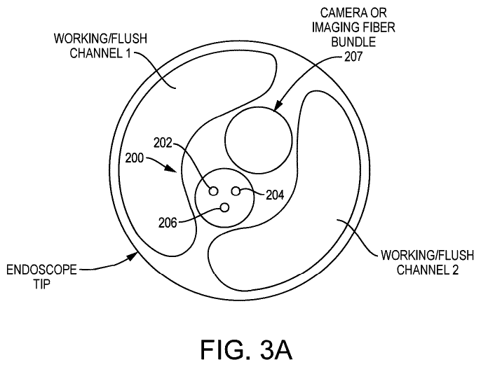

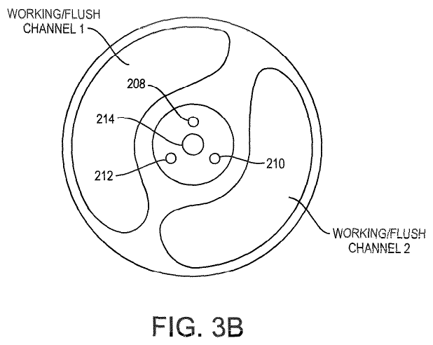

A variety of the light sources can be employed in the practice of the present teachings. By way of example, FIG. 3A shows a red/green/blue (RGB) light source that includes a blue light source 202, a red light source 204 and a green light source 206. In this example, the RGB light source is coupled to the distal end of an endoscope with the endoscope's camera 207 positioned in proximity of the RGB light source to capture visible radiation reflected by a target tissue as well as the fluorescent radiation emitted by the target tissue in response to excitation by the blue light. An example of this may be an RGB 3 chip LED or three individual fibers, one from each spectral channel.

By way of further illustration, FIG. 3B shows that in some embodiments, a blue light source 208, a red light source 210 and a green light source 212 surround a camera 214 of an endoscope. In some embodiments, the light sources and the camera can be mounted on the same mount. The radiation generated by the light sources can illuminate the target biological sample and the camera can generate visible and fluorescent image data. In each embodiment, the light sources can be individually addressable, e.g., to allow temporal modulation of the red light source or the combination of the red and green light sources. As discussed above, in some embodiments, in addition to the red, the green and the blue light sources, an additional blue light source generating blue light at a shorter wavelength than the blue light generated by the blue light source 208 can also be provided.

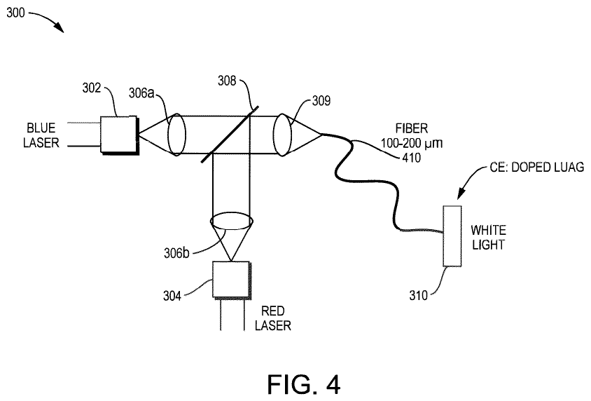

With reference to FIG. 4, in various embodiments, rather than using the green laser light, a phosphorescent material can be coupled to the distal end of the optical fiber, where the phosphorescent material can be excited via the blue laser light to generate phosphorescent radiation with wavelengths between the red and the blue laser wavelengths. More specifically, FIG. 4 schematically depicts an example of such a diagnostic system 300 that includes a blue laser light source 302, and a red laser light source 304. Two collimating lenses 306a and 306b receive the blue and the red laser light and provide collimated light beams.

The blue and the red light beams can be coupled via a beam splitter 308 and an optical coupler 309 into the proximal end of an optical fiber 410. A phosphorescent material 310 can be coupled to the distal end of the optical fiber 410 to receive the radiation propagating through the optical fiber and generate phosphorescent radiation. By way of example, and without limitation, the phosphorescent material can include Cerium atoms distributed within a host material. By way of example, the host material can be a YAG crystal, a LuAG crystal or a GGAG crystal. In some embodiments, the phosphorescent element can be Cerium:YAG powder, or Cerium:LuAG powder that is sintered onto a substrate, such as glass or sapphire, or a Cerium-doped phosphor glass composite.

By way of example, the blue laser light can excite the phosphorescent material to generate phosphorescent radiation, which in combination with the red and the blue laser light can generate white light for illuminating the target tissue, e.g., for visual inspection. Further, in various embodiments, the red laser light can be modulated, e.g., it can be periodically turned off and on, such that during the time intervals in which the red laser light is off, fluorescent radiation emanating from a target biological sample, e.g., due to the excitation of the sample by the blue light, can be detected. In various embodiments, it may also be advantageous to modulate the green light channel with the red channel so that only the blue light is on during the fluorescent diagnostic frame grab. For example, a camera can frame grab images during periods in which the red laser is in the off state and have full white spectral coverage during periods in which the red laser is in the on state. It is further helpful to monitor the red channel from the camera to eliminate green, and one or two blue lights that will be filtered out.

In one embodiment, Ce:LuAG is utilized as the phosphorescent element as it can be particularly useful in diagnostic applications as there is almost no red emission when excited by the blue laser. This eliminates the background red that would be otherwise observed using phosphorescent elements that have red emission.

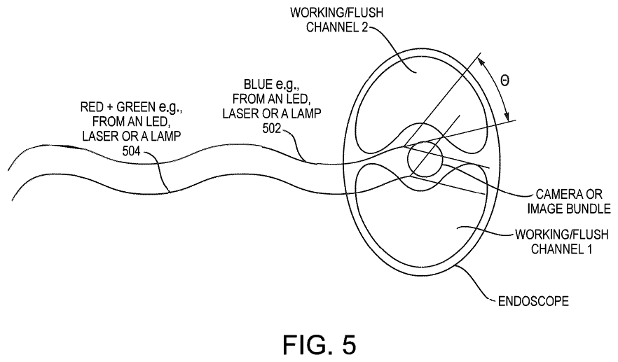

FIG. 5 schematically depicts that in an embodiment of a diagnostic system according to the present teachings incorporated in an endoscope (or other devices), an optical fiber 502 can be used for delivery of the blue light and/or first and second blue lights, e.g., generated by a lamp, an LED or a laser, to a target region and another optical fiber 504 can be utilized for the delivery of the modulated red and optionally green light to that target region, e.g., generated by a lamp, and LED or a laser.

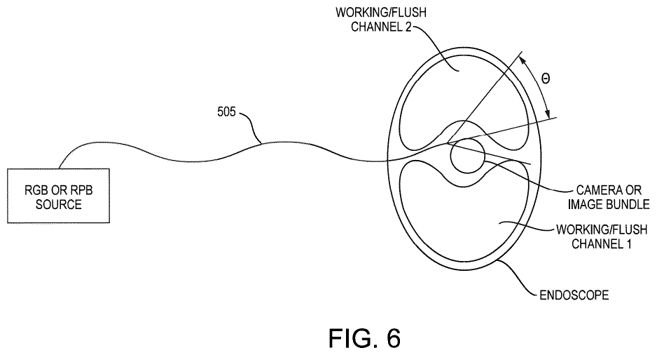

FIG. 6 schematically depicts that in another embodiment of a diagnostic system incorporated into an endoscope (or other device), an optical fiber 505 can receive radiation from an RGB or an RPB light source and deliver the radiation to the distal end of the endoscope for illuminating a target tissue. The endoscope's camera can in turn collect the visible radiation reflected by the target tissue or the fluorescent radiation emitted by the target tissue for generating visible and fluorescent images of the target tissue.

A variety of fluorophores can be used in the practice of the present teachings. By way of example, in some embodiments, native fluorophores, such as co-enzymes FAD (Flavin adenine dinucleotide) and NADH (Nicotinamide adenine dinucleotide), can be employed. In other cases, an exogenous fluorophore, e.g., a dye, can be added to the target tissue to act as the fluorophore. An example of an exogenous fluorophore is ALA marketed as Cysview™ by Photocure. This dye has been shown to be particularly useful in visualizing cancerous regions of tissue using blue light fluorescence. The peak pump radiation wavelength for this particular fluorophore is 405 nm, which can be provided by a second blue source in various embodiments.

In an aspect, a diagnostic method is disclosed that generates both reflection and fluorescent images of a target sample (typically a target biological sample, such as a tissue sample) by illuminating the target sample by light generated by a modulated white light source and light generated by a continuous wave (CW) fluorescence-inducing light (CW) source, such as light at a wavelength of 405 nm. During the periods in which the white light is on, image data associated with reflection/scattering of the white light by the target sample is collected and during the periods in which the white light is off, image data associated with fluorescent radiation emanated from the target sample is collected. The image data is analyzed to generate a reflection image and a fluorescent image of the target sample.

As discussed in more detail below, this method unexpectedly produces a vibrant visible image without deleterious effects such as banding, despite the presence of the continuous fluorescence-inducing light (e.g., violet/near-UV light) and the high-frequency modulation of the white light source.

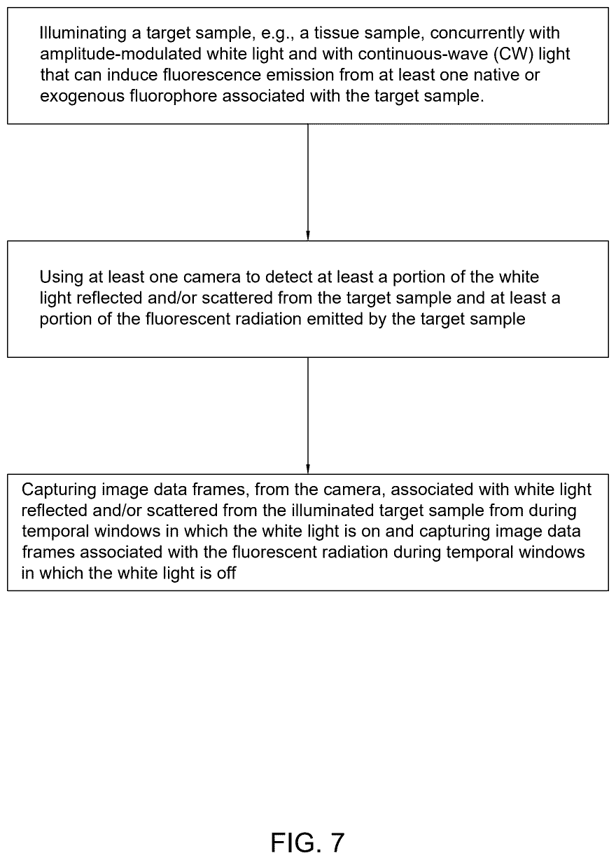

With reference to the flow chart of FIG. 7, a diagnostic method according to an embodiment includes illuminating a target sample, e.g., a biological tissue sample (such as a target tissue sample), concurrently with a modulated white light and with a continuous-wave (CW) light that can induce fluorescence emission from at least one native or exogenous fluorophore associated with the target sample. By way of example, the modulated white light can be generated by a light source having red, green, and blue light-emitting light source units (e.g., red, green, and blue laser diodes), which is generally referred to as an RGB light source. Such an RGB light source can be driven by a temporal modulation signal, such as a Transistor-Transistor Logic (TTF) signal. In various embodiments, the modulation signal can cause the RGB light source to alternate between an “on” state, in which it emits white light, and an “off” state, in which the light emission is ceased or is reduced to a negligible level. By way of example, the duty cycle of the modulated white light can be in a range of about 10% to about 90%, and more typically, in a range of about 25% to about 75%. Further, in various embodiments, the modulation frequency of the white light source can be at least 500 Hz, e.g., in a range of about 500 Hz to about 1 kHz, so that it would not interfere with the generation of the fluorescent image.

In various embodiments, pulse-width modulation (PWM) is utilized to adjust the duty cycle and hence the output power of the white light source. As noted above, and discussed in more detail below, the adjustment of the duty cycle of the white light source also results in adjustment of the temporal periods in which the fluorescence image data is collected. In various embodiments in which a single detector is used to detect both the reflection light and the fluorescent light, the gain of the detector is automatically adjusted as the detector switches from the detection of the reflection light to that of the fluorescent light. As the fluorescent light has typically a much lower intensity than that of the reflection light, in various embodiments, the gain of the detector is increased when the detector switches from the detection of the reflection light to that of the fluorescent light. The detector's gain is then increased when the detector switches from the detection of the fluorescent light to the detection of the reflection light. In this manner, a dynamic change of the detector's gain is implemented to ensure that in each cycle, the gain is suitable for the acquisition of the reflection and the fluorescent light.

In various embodiments, the duty cycle of the modulated white light can be changed, for example, based on the expected intensity of the fluorescent light to be emitted from a target sample. For example, when imaging a tissue target, the duty cycle of the modulated white light can be adjusted based on the depth of a target tissue relative to the output end of an optical fiber used to illuminate the target tissue. More specifically, in such embodiments, as the depth of the target tissue increases, the duty cycle of the modulated light is decreased to allow more time for the collection of the fluorescent light in each measurement cycle.

In various embodiments, the fluorescence-inducing radiation can be generated by a CW light source that is configured to generate light with a wavelength in a range of near-UV to blue, e.g., in a range of about 405 nm to about 480 nm.

In some embodiments, the white light (e.g., an RGB light) and the fluorescence-inducing (e.g., near-UV/violet) light are delivered to the target sample via a common (single) optical fiber. More specifically, the white light source and the fluorescence-inducing light source are optically coupled to an input end of a single optical fiber whose output end is optically coupled to the target tissue sample to deliver the white light and the fluorescence-inducing light to the target sample.

At least a portion of the reflected and/or scattered white light and at least a portion of the fluorescent radiation emitted from the target sample are detected and processed to generate a reflection as well as a fluorescent image of the target sample. More specifically, in various embodiments, one or more optical detectors (such as a digital camera) and an image processor can be operated in synchrony with the modulation of the white light source to generate visible and fluorescent images. By way of example, during the “on” periods of the white light source, the image processor can capture frames of the reflected/scattered white light from the camera. The image processor then uses these frames to construct a real-time, reflection image of the target. During the “off” periods of the white light, the image processor can capture frames associated with the fluorescent radiation from the camera. During the “off” periods, the only significant light being emitted from the target sample is the fluorescent radiation induced by the CW near-UV/violet source. In some embodiments, the fluorescent radiation emanating from the target sample is detected by frame grabbing the red channel of the camera during the “off” states of the white light source.

The duty cycle of the modulated white light and the intensity of the CW fluorescence-inducing light can be adjusted such that gain adjustments between the capture of the reflection and the fluorescence image data are not required, simplifying the data acquisition/processing and providing a seamless viewing experience. The reflection and fluorescent images can then be presented to a user on a display, either side-by-side or as an overlay.

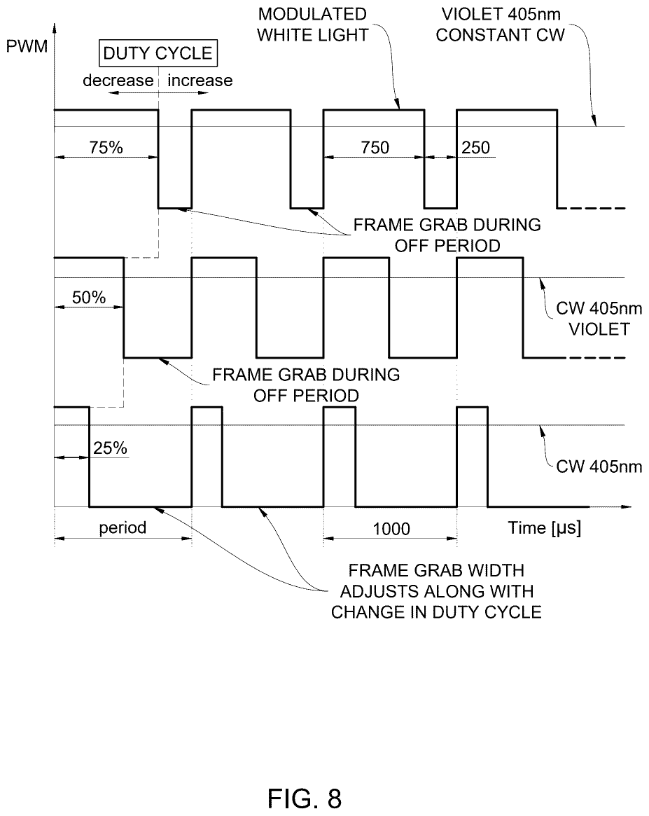

By way of further illustration of various embodiments of the above diagnostic method, FIG. 8 provides three schematic diagrams in Panels A, B, and C, illustrating various examples of implementation of a diagnostic method according to the present disclosure. Without any loss of generality, in these examples, the fluorescence-inducing light is assumed to be a monochromatic light at a wavelength of 405 nm, which continuously illuminates the target sample, causing it to fluoresce. The white light source is rapidly turned on and off using a Pulse Width Modulation (PWM) signal, where the duty cycle determines the ratio of the temporal periods during which the white light is on relative to the temporal periods during which the white light is off.

In these examples, the acquisition periods of the reflection and fluorescent image data are synchronized with the modulation of the white light. More specifically, as noted above, the reflection image data is acquired when the modulated white light is on and the fluorescent image is generated exclusively based on the fluorescent light emitted during the temporal periods in which the white light source is off. In such temporal windows, the only light signal available for capture is the fluorescent light emitted by the target.

The diagrams presented in Panels A, B, and C demonstrate how changing the duty cycle of the modulated white light affects the time available for acquiring the fluorescence image data. For example, in the diagram depicted in Panel A, the duty cycle of the modulated white light is 75%; that is, within each 1000-μs cycle, the white light is on for 750 μs and is off for 250 μs. A reflection image can be generated based on detected white light that is reflected/scattered by the illuminated target during the 750-μs period in which the white light is on and a fluorescent image can be generated based on detected fluorescent radiation emanating from the illuminated target during the 250-μs period in which the white light is off.

In the example depicted in Panel B, a reduced duty cycle of 50% is employed for the modulation of the white light source. Thus, in this example, the white light source is on for 500 μs and is off for 500 μs during each 1000-μs cycle. The data for the generation of the reflection image is collected during the on periods of the white light source and the data for the generation of the fluorescent image is collected during the off periods of the white light source. In this example, the temporal window for the fluorescent “frame grab” has increased to 500 μs, thus doubling the amount of time available for capturing the fluorescent signal relative to that in the previous example in which the duty cycle of the modulated white light was 75%.

Finally, in the example depicted in Panel C, the duty cycle of the modulated white light has been further decreased to 25%. Thus, in this example, the white light is on for only 250 μs and is off for 750 μs in each 1000-μs cycle. Thus, the modulation arrangement provides the longest temporal window of the three examples for the acquisition of data for the generation of the fluorescent image. This extended fluorescent “frame grab” temporal window is particularly advantageous for capturing a strong fluorescent signal, especially for weak fluorescence emissions.

In general, the duty cycle is optimized to maximize the acquisition window for the fluorescent signal, while ensuring the white light's “on time” is adequate to capture a clear and acceptable reflection image of the target sample.

In various embodiments, the system described above in connection with FIG. 1B can be modified to provide an example of a system for implementing the above method in which a target sample, such as a target biological sample, is concurrently illuminated with a modulated white light and a continuous fluorescence-inducing light. As discussed in detail above, system 100′ includes three laser radiation sources 102, 104, and 106 configured to generate blue, red and green light, respectively. The light beams emitted by these sources are combined by two beam splitters 108a/108b onto a coaxial path along which they propagate to reach optical coupler 109, which couples the combined beams into the proximal end of optical fiber 110. As noted above, in various embodiments, the output power of the laser light sources can be in a range of about 0.1 W to about 1 W.

System 100′ also includes a fluorescence-inducing light source 102a (B2) that can generate light (e.g., monochromatic light with a wavelength of about 405 nm) for exciting a native or an exogenous chromophore of the target sample, which can in turn generate fluorescent radiation. The fluorescence-inducing light generated by the light source 102a is coupled via beam splitter 108c into optical fiber 110.

In this embodiment, controller 112 that is in communication with the light sources 102/104/106 as well as fluorescence-inducing light source B2 is configured (e.g., programmed) to cause modulation of the light sources 102/104/106 upon their activation using, e.g., TTL modulation, to generate modulated white light emitted from the optical fiber 110. The controller is further configured to maintain the fluorescence-inducing light source 102a in an “on” state throughout each measurement cycle.

As discussed above in connection with FIG. 1B, system 100 further includes a camera 113 that is positioned in proximity of the target biological sample and can collect at least a portion of the illuminating white light that is reflected/scattered from the target sample as well as the fluorescent radiation elicited from the sample in response to illumination thereof by the fluorescence-inducing light. An image processor/frame grabber 114 is in communication with camera 113 to receive the image data collected by the camera and process the image data to generate a reflection and a fluorescent image.

In this embodiment, controller 112 is in communication with the image processor/frame grabber 114 and is configured to cause the image processor/frame grabber 114 to grab the image data corresponding to the fluorescent radiation emitted by the biological sample during temporal windows in which modulated white light source is off. Further, controller 112 is configured to cause the image processor/frame grabber 114 to grab image data corresponding to the red/blue/green light during temporal windows in which the white light source is on. The image processor/frame grabber is configured to process the grabbed frames to generate a reflection and a fluorescent image of the target sample. Display 116 can be employed to present the reflection and the fluorescent images to a user.

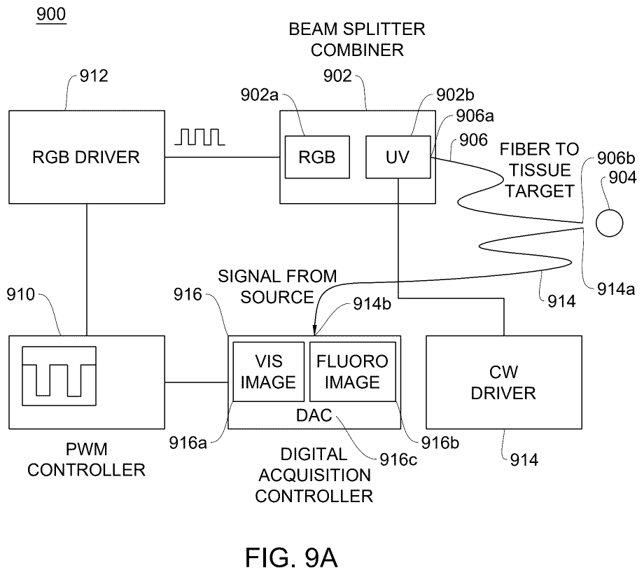

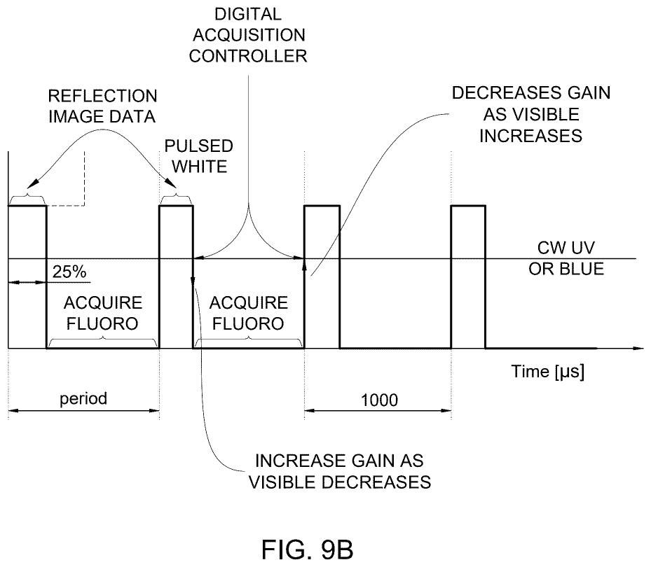

By way of further illustration, FIG. 9A includes a system 900 according to an embodiment, which includes a light source unit 902 having an RGB light source 902a (which includes a red laser light source, a blue laser light source, and a green laser light source) for generating white light and a UV light source 902b for eliciting fluorescent light from a target sample 904, such as a tissue target. Though not visible in this figure, one or more beam splitters can be utilized, e.g., in a manner discussed above in connection with system 100, to combine the white and the UV light beams along a coaxial direction for coupling into a proximal (input) end 906a of an optical fiber 906. The combined white and UV light beam exits a distal (output) end 906b of the optical fiber for illuminating a target sample 904. A PWM controller 910 controls operation of a driver 912 for operating the red, blue and green laser light sources to cause the modulation of the light intensity emitted by those light sources. Further, a CW driver controls the operation of the UV light source to maintain the UV light source in an activated state throughout the measurement cycles.

With continued reference to FIG. 9A as well as FIG. 9B, another optical fiber 914 receives at least a portion of the white light reflected/scattered by the target sample as well as at least a portion of the fluorescent light emitted by the target sample in response to excitation of one or more fluorophores of the target sample via the UV light at an input port 914a thereof and transmits the received white light and fluorescent light to its output port 914b, which is optically coupled to an image data detection unit 916, which includes an imager 916a for the detection of the reflection light and a fluorescence imager 916b for the detection of the fluorescent light. The detection unit further includes a digital acquisition controller 916c for controlling the operation of the visible imager 916a and the UV imager 916b, including adjusting the gain of the imagers. In some embodiments, the functionality of both imagers can be incorporated in a single device, e.g., a single photodetector.

The PWM controller 910 is in communication with the digital acquisition controller 916c to provide information about the modulation of the white light source thereto. The controller 916c can operate the imagers, based on the information it receives from the PWM controller, such that reflection image data is acquired during the temporal periods in which the white light source is on and the fluorescence image data is acquired during the temporal periods in which the white light source is off.

Further, in some embodiments in which a single detector functions as both the reflection and the fluorescence imager, the digital acquisition controller 916c is configured to adjust the gain applied to the reflection and the fluorescence imagers in a manner discussed above. For example, the digital acquisition controller 916c can increase the gain applied to the detector as the detector switches from the detection of the reflection light to the detection of the fluorescent light and re-adjusts the gain back when the detection switches from the detection of the fluorescent light back to the detection of the reflection light.

In some embodiments, a bundle of optical fibers can be utilized to illuminate the target sample and/or collect the fluorescent light emitted by the target sample. Further, in some embodiments, rather than utilizing an optical fiber to receive the fluorescent light emitted from a target sample and transmit the received fluorescent light to a camera optically coupled to a distal end of that optical fiber, such as discussed above in connection with system 900, a camera in the form of a chip can be positioned in proximity of the target sample to directly collect and detect the fluorescent light emitted by the target sample (See, e.g., FIG. 1B).

The above diagnostic method utilizing concurrently a modulated white light and a CW fluorescence-inducing light represents a fundamental and counter-intuitive departure from conventional prior art approaches for generating combined reflection and fluorescent images of a target sample. Prior art systems typically rely on pulsing both the white light source and the fluorescence excitation source in a strictly alternating, time-multiplexed manner. In such systems, a reflection image is acquired by turning the white light on while the excitation light is off. Subsequently, to acquire a fluorescent image, the system enters a distinct “fluorescence mode” where the white light source is turned completely off and the excitation light is pulsed on. The fluorescence data is collected only during these specific, dedicated time intervals.

In stark contrast, the present method teaches the opposite approach: the fluorescence-inducing light source (e.g., a violet/near-UV light source) is maintained in an activated state continuously, while only the visible white light source is modulated (typically, at a rapid rate, e.g., 500 Hz or higher). It was unexpectedly discovered that this method is highly effective. Experts in the field would have predicted that a continuously active near-UV source would interfere with the acquisition of the reflection image, potentially adding a violet color cast, reducing image vibrancy, or otherwise degrading the quality of the visible diagnostic image.

Without being limited to any particular theory, in some embodiments, the disclosed method unexpectedly produces a vibrant and clear white light image with no deleterious effects, as a result of the camera's low response to the violet wavelength and the low reflectivity of the target at this wavelength.

In various embodiments, an eye-safe illumination system disclosed in published International Application No. PCT/US2024/035015 entitled “Eye Safe Illumination System,” which is herein incorporated by reference in its entirety can be used to illuminate a target sample with visible (e.g., white) light. Briefly, this patent application discloses an illumination system that includes at least one radiation source for generating radiation, an optical fiber extending from a proximal end configured to receive the radiation from the radiation source to a distal end through which radiation can exit the optical fiber, an inorganic radiation-diffusing element extending from a proximal end to a distal end, where the proximal end of the radiation-diffusing element is optically coupled to the radiation source to receive radiation therefrom. The radiation-diffusing element is configured to cause scattering of the received radiation so as to increase an angular distribution of the received radiation, an organic radiation-diffusing element extending from a proximal end to a distal end, where the proximal end of the organic radiation-diffusing element is optically coupled to the distal end of the inorganic radiation-diffusing element so as to receive at least a portion of the radiation exiting the inorganic radiation-diffusing element, where the organic radiation-diffusing element causes further scattering of the radiation received from the inorganic radiation-diffusing element to generate an output radiation pattern.

In various embodiments, the fluorescent radiation collected from a target tissue of interest can be analyzed, for example, to detect a particular disease condition.

Those having ordinary skill in the art will appreciate that various changes can be made to the above embodiments without departing from the scope of the present teachings.

What is claimed is:

1. A diagnostic method for imaging a target sample, comprising:
concurrently illuminating the target sample with a temporally modulated white light that alternates between an “on” state and an “off” state and a continuous wave (CW) fluorescence-inducing light,
acquiring reflection image data from the target sample during the “on” state of the modulated white light,
acquiring fluorescence image data from the target sample during the “off” state of the modulated white light, and
processing the acquired reflection and fluorescence image data to generate a reflection image and a fluorescent image of the target sample.

2. The method of claim 1, wherein the steps of acquiring reflection image data and acquiring fluorescence image data are performed by a single optical detector, the method further comprising automatically adjusting a gain of the single optical detector.

3. The method of claim 2, wherein said automatically adjusting the gain comprises increasing the gain of the single optical detector for the acquisition of the fluorescence image data relative to a gain used for the acquisition of the reflection image data.

4. The method of claim 3, wherein the gain is increased when switching from acquiring the reflection image data to acquiring the fluorescence image data to compensate for a lower intensity of the fluorescent light compared to the reflection light.

5. The method of claim 1, wherein the target sample is a biological sample, and wherein said biological sample comprises a tissue sample.

6. The method of claim 1, wherein the fluorescence-inducing light has a wavelength in a range of about 405 nm to about 480 nm.

7. The method of claim 1 wherein the modulated white light is generated by superposition of light beams generated by a red, a green and a blue light source.

8. The method of claim 7, wherein light emitted by each of said red, green and blue light sources is modulated to generate said modulated white light.

9. The method of claim 8, wherein any of said red, green and blue light sources is modulated via Transistor-Transistor Logic (TTL) modulation.

10. The method of claim 1, wherein said modulated white light has a duty cycle in a range of about 10% to about 75%.

11. The method of claim 1, wherein said modulated white light and said CW fluorescence-inducing light are delivered to the target sample via a single optical fiber.

12. The method of claim 1, wherein said steps of acquiring the reflection and the fluorescence image data comprises utilizing at least one digital camera.

13. The method of claim 12, further comprising utilizing a red channel of said digital camera to acquire said fluorescence image data.

14. The method of claim 1, further comprising presenting the reflection and the fluorescent images on a display to a user.

15. The method of claim 14, wherein said reflection and fluorescent images are displayed side-by-side.

16. The method of claim 14, wherein said reflection and fluorescent images are displayed as an overlay.

17. The method of claim 1, wherein said white light has an intensity in a range of about 50 to about 150 mW.

18. The method of claim 1, wherein said fluorescence-inducing light has an intensity in a range of about 15 to about 50 mW.

19. A diagnostic system for generating an image of a target sample, comprising:
at least one white light source configured to generate temporally modulated white light alternating between an “on” and an “off” state;
at least one fluorescence-inducing light source configured to generate light at a wavelength that causes the target sample to fluoresce;
at least one optical detector configured to detect at least a portion of the white light reflected or scattered from the target sample and at least a portion of fluorescent light emanating from the target sample,
an image processor in communication with said at least one optical detector to capture image data corresponding to said reflected or scattered white light and said fluorescent light,
a controller in communication with said white light source, said fluorescence-inducing light and said optical detector are configured to:
cause the white light source to be temporally modulated between the “on” state and the “off” state,
cause the fluorescence-inducing light source to continuously illuminate the target sample during both the “on” and the “off” states of the white light source,
cause the image processor to collect visible image data during “on” states of the white light source and to collect fluorescence image data during “off” states of the white light source.

20. The diagnostic system of claim 19, wherein the at least one optical detector is a single optical detector configured to acquire both the reflection image data and the fluorescence image data, and wherein the controller is further configured to dynamically adjust a gain of the single optical detector during each measurement cycle.
